(19) United States
(12) Patent Application Publication
(10) Pub. No.: US 2003/0182376 A1
(43) Pub. Date: Sep. 25, 2003

(54) Distributed processing multi-processor computer

(76) Inventor: Neale Bremner Smith, Northumberland (GB)

Correspondence Address: SALTAMAR INNOVATIONS, 30 FERN LANE, SOUTH PORTLAND, ME, 04106, US

(21) Appl. No.: 10/276,634

(22) PCT Filed: May 18, 2001
(86) PCT No.: PCT/GB01/02166

(30) Foreign Application Priority Data
May 19, 2000 (GB) 0011972.7
May 19, 2000 (GB) 0011977.6

(51) Int. Cl. G06F 15/16

(52) U.S. Cl. 709/205; 709/214

(57) ABSTRACT

The present invention describes a multi-processor computer system (10) based on dataflow principles. The present invention relates to distributed processing in a shared memory computer and provides a memory controller (14) that is able to perform logical and arithmetic operations on memory (15) on behalf of a processor (11), each memory leaf having its own controller. A processor need only make a single memory transaction to perform complex operations and does not need critical sections in order to resolve memory contention.

The present invention relates to multi-processor computers, and in particular distributed processing in multi-processor computers.

Multi-processor computers are used to execute programs that can utilise parallelism, with concurrent work being distributed across the processors to improve execution speeds. They can take many forms, but programming requirements are complicated by issues such as shared memory access, load balancing, task scheduling and parallelism throttling. These issues are often handled by software to get the best effect, but to obtain the best speed it is often necessary to handle them in hardware, with consequently higher material costs and circuit complexity.

In a shared memory computer all the processors are connected to a logically single block of memory (it may be physically split up, but it appears single to the processors or software). In such a system all the processors are potentially in contention for access to the shared memory, thus network bandwidth is a valuable resource. Plus, in many systems the latency between processor and memory can be high. For these reasons it can be costly to use a shared memory and performance can be degraded. There are also many problems when atomic (indivisible) operations on memory are required, such as adding a value to a memory location. Such problems are often overcome by the use of critical sections, which in themselves are inefficient, as explained by the following prior art example.

A conventional small-scale shared-memory arrangement for multi-processing memory comprises multiple memory controllers sharing a single bus to a common block of RAM with an arbiter preventing bus contention. When using shared memory, a programmer has to either:

(a) know that the data is not and cannot be accessed by anyone else while his or her program is working with it; or

(b) lock other people out of using the data while his or her program is working on it, and unlock it when finished.

Option (a) cannot always be guaranteed, so (b) is often preferred. To implement (b), the program will normally create a critical section. This may use a semaphore lock which is a test and set (or more generally a swap) operation. To avoid contention, the data must not be accessed, except by code within the critical section. So before a program can act on data, the critical section semaphore lock is tested and set automatically, and if the test shows that it is already locked, then the program is not allowed to enter the section. If the semaphore lock was clear, then the automatic set operation blocks other access immediately, and the program is free to continue through the section and operate on the data. When the program is finished with the data, it leaves the section by clearing the semaphore lock to allow others access.

In hardware, a critical section will normally be implemented by requesting the bus, waiting for permission from an arbiter during the test and set or swap and then releasing the bus. This is convenient when utilising circuit-switched connections between processor and memory, but difficult to achieve across packet-switched networks, so typically packet-switched networks between processors and memory do not utilise hardware implementation of critical sections.

It would be advantageous to provide a system which allowed resolution of memory contention in a multi-processor system connected over a packet-switched network with shared memory. Furthermore, it would be advantageous to allow the processors to operate and be programmed as a shared memory system, but the memory to be distributed for efficiency when it comes to accessing memory.

Within this document, including the statements of invention and Claims, the term “atomic” refers to an indivisible processing operation.

It is an object of the present invention to provide a system for shared memory accesses of distributed memory in a multi-processor computer.

According to a first aspect of the present invention, there is provided a multi-processor computer system comprising a plurality of processors and a plurality of memory units, characterised in that each memory unit is operated on by its own memory controller means for the purpose of performing processing operations on said memory unit.

Preferably, said processing operations are atomic.

Preferably, said plurality of processors are connected to said plurality of controller means by a network.

More preferably, said plurality of processors are connected to said plurality of controller means by a packet-switched network.

Preferably, said network connecting said plurality of processors to said plurality of controller means defines a hyper cube topology.

Preferably, said network connecting said plurality of processors to said plurality of controller means comprises a plurality of nodes, wherein each node comprises a router, and at least one other element being selected from a list consisting of:

a processor;

a memory controller means; and

a memory unit.

Preferably, said plurality of processors compile at least one transaction packet which comprises information, and being selected from a list consisting of:

information related to routing said transaction packets to a memory controller means;

information which specifies a processing operation;

information related to routing said transaction packets back from said memory controller means; and

information related to matching said transaction packet to a process thread.

Preferably, each of said plurality of processors is associated with a unique identifier for the purpose of routing.

Preferably, each of said plurality of memory controller means is associated with a unique identifier for the purpose of routing.

Preferably, the memory controller means accesses a block of RAM.

Optionally, said memory controller means provides input/output facilities for peripherals.

Preferably, said memory controller means comprises processing elements being selected from a list consisting of:

a processing operation request input buffer;

a processing operation decoder;

a memory access stage;

an arithmetic logic unit;

a set of registers; and

a processing operation result output buffer.

Optionally, said memory unit is a computer memory divided into frames.

Optionally, said memory unit defines a computer memory leaf which comprises one or more frames.

Optionally, said plurality of memory units are interleaved at the frame level.

Optionally, a set of bits of logical addresses are equated to the network position of said leaves.

Optionally, the address of at least one of said frames are mapped to a virtual address.

Optionally, said virtual address corresponds to the same leaf as the physical address of the frame to which the virtual address refers.

Optionally, a set of registers in the memory controller means hold pointers to link lists for allocating said frames of memory.

According to a second aspect of the present invention, there is provided a method of performing processing operations in a shared memory multi-processor computer comprising the steps of;

requesting that a memory controller means perform a processing operation on a memory unit; and

said memory controller means performing said requested processing operation on said memory unit;

characterised in that each storage unit is operated on exclusively by its own memory controller means.

Optionally, said memory controller means divides said processing operation into micro-operations which are performed by a pipeline of said processing elements.

In order to provide a better understanding of the present invention, an embodiment will now be described by way of example only, and with reference to the accompanying Figures, in which:

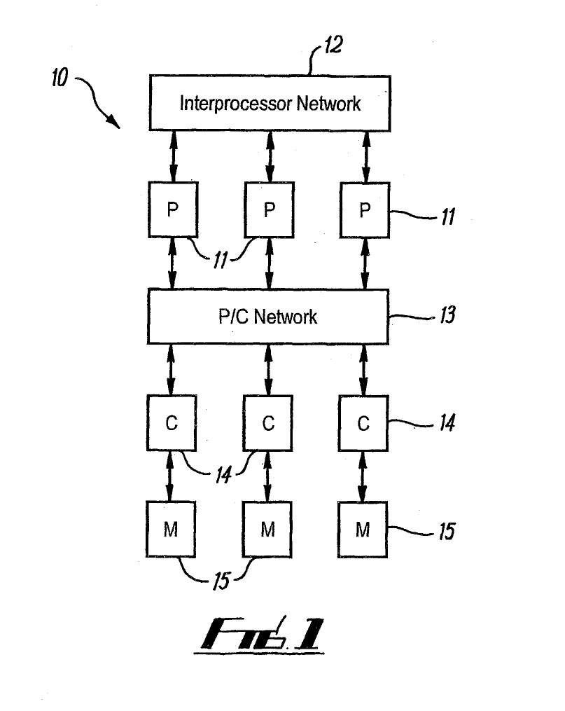

FIG. 1 illustrates, a multi-processor computer system in accordance with the invention; and

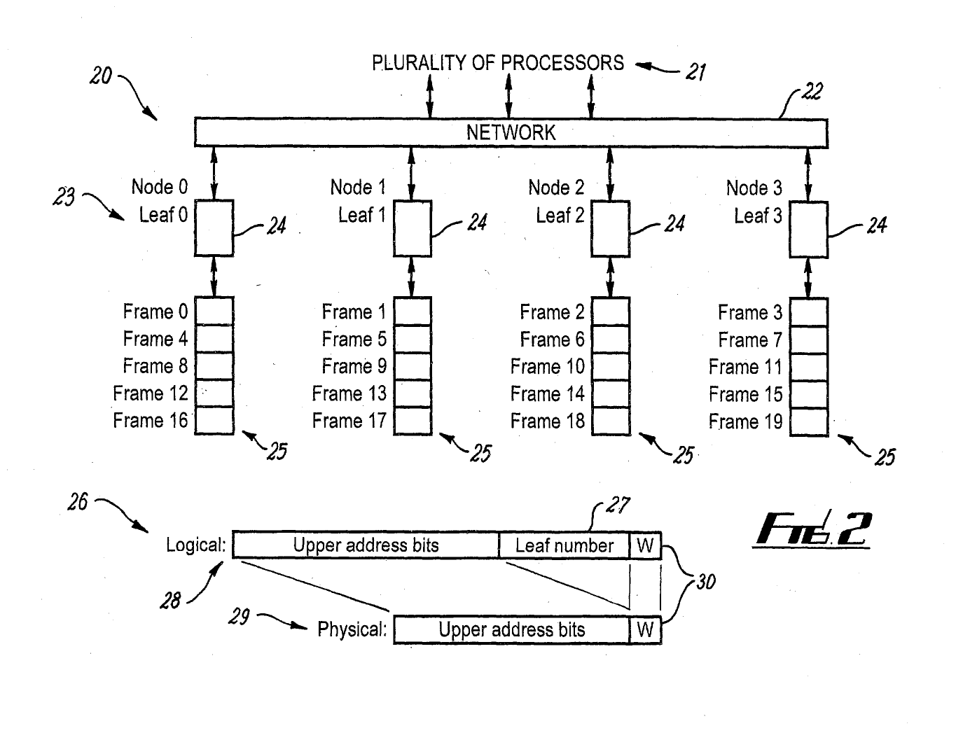

FIG. 2 illustrate the memory configuration divided into interleaved frames.

Although the embodiments of the invention described with reference to the drawing comprise computer apparatus and processes performed in computer apparatus, the invention also extends to computer programs, particularly computer programs on or in a carrier, adapted for putting the invention into practice. The program may be in the form of source code, object code, a code of intermediate source and object code such as in partially compiled form suitable for use in the implementation of the processes according to the invention. The carrier may be any entity or device capable of carrying the program.

For example, the carrier may comprise a storage medium, such as ROM, for example a CD ROM or a semiconductor ROM, or a magnetic recording medium, for example, floppy disc or hard disc. Further, the carrier may be a transmissible carrier such as an electrical or optical signal which may be conveyed via electrical or optical cable or by radio or other means.

When the program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

FIG. 1 illustrates, in schematic form, a multi-processor computer system in accordance with the invention. The multi-processor computer system 10 of FIG. 1 comprises processors 11; the interprocessor communication network 12; the processor to memory controller communication network 13; the memory controllers 14 and RAM memory leaves including optional I/O interfaces 15. The memory 15 is physically distributed, acting as interleaved blocks in a logically unified address space, thus giving a shared memory model with high bandwidth.

The processors use a dataflow execution model in which instructions require only data to arrive on only one input to ensure their execution and can fetch additional data from a memory. Where two or more inputs are required, with at least two not coming from memory, this is termed a ‘join’ and an explicit matching scheme is used where typically, all data are written to memory and only one input is used to initiate execution of the instruction. The instruction will then fetch the data from the memory. Resulting data is then passed to the inputs of none, one, or more destination instructions. If sent to none, then the data is destroyed and no further action is taken. If sent to one destination then the instruction at the destination will receive the data and execute. If sent to more than one destination then a ‘fork’ occurs and all destinations will receive an individual copy of the data and then execute concurrently.

Data arriving at an input is built from a group of tokens. Such a group is analogous to a register bank in a RISC processor and include items such as status flags and execution addresses, and collectively hold all the information needed to describe the full context of a conceptual thread. Like registers in a RISC machine, none, one, or more tokens in the group can be used by an executing instruction either in conjunction with or in lieu of a memory access. For clarity, a group of tokens is hereafter referred to as a ‘thread’ and the token values are collectively referred to as the ‘thread context’. When a fork occurs, a new thread is ‘spawned’. When a join occurs, the threads are merged into one, and this merged thread continues past the point of joining.

The level of work in a processor is known as the ‘load’ and is proportional to the number of threads in concurrent existence. This load is continually monitored. The processor is composed of several pipeline stages logically connected in a ring. One instruction from each concurrent thread exists in the pipeline, with a stack used to hold threads when there are more threads than pipeline stages. An instruction cannot start execution until the instruction providing its inputs has completed execution. Thus an N stage pipeline will require N clock cycles to complete each instruction in a thread. For this reason, many threads can be interleaved, so N threads will together provide N independent instructions which can travel through the pipeline in consecutive slots, thus filling the pipeline.

When more than N threads exist, the excess are held in a dedicated thread stack. When the stack fills up a throttle is used to prevent it overflowing. The throttle is invoked when the load exceeds a given upper threshold. An executing thread is chosen by the processor and, by rewriting the destination addresses for the data, diverted into a software routine which will write the context data into a memory frame, attach the frame to a linked list (the ‘context list’) in memory, and then terminate the thread. This process continues periodically until the load falls below the upper threshold.

A resurrection process is invoked when the load falls below a given lower threshold. A new thread is created by the processor and executes a software routine which inspects the linked list and, if possible, removes a frame from the list, loads the context data, and assumes the context data for itself. The new thread has now become a clone of the original thread that was throttled, and can continue execution from where the original left off before it was diverted.

All threads will pass through the pipeline stage containing the dedicated thread stack. For each clock cycle the processor will determine which thread in the stack is most suitable for insertion in the pipeline on the next cycle. In the preferred embodiment logic will exist to make intelligent decisions to ensure that every thread gets a similar amount of processing time and is not left on the stack indefinitely.

All processors in a system are connected by an interprocessor network. In the preferred embodiment this will consist of a unidrectional ring network, with only adjacent processors connected. Each pair of adjacent processors consists of an ‘upstream’ processor and a ‘downstream’ processor. The upstream processor informs the downstream processor of its load. The downstream processor compares this to its own load, and if it is less loaded than the upstream processor it sends a request for work from the upstream processor. The upstream processor will then remove a thread from its pipeline and route it out to the network where it will be transferred to the downstream processor. The downstream processor will then insert the thread into its own pipeline. This ensures that the downstream processor is never less loaded than the adjacent upstream processor, and because of the ring arrangement, every processor is downstream of another processor, and hence the entire ring is inherently balanced.

When an instruction needs to access memory, either for a read or a write it must access the shared memory across the processor/memory network. On every clock cycle the threads held in the thread stack are inspected to see if any need to access memory. If any do, then the processor compiles a transaction packet for at least one of the threads. The packet contains all the information required to inform a remote memory controller of what is required and how to route the data there and back. In particular, a unique ID is assigned to a thread so when the result is returned it will carry the ID and the target thread can be identified. This packet is placed in a memory buffer.

Incoming packets containing the results of transactions are inspected and, by virtue of the unique ID, the contents matched with threads waiting in the thread stack.

In the preferred embodiment, an instruction cache and/or data cache will be used to reduce the number and rate of memory transactions. The memory buffer can be any depth and can incorporate data caching and write merging if desired.

The preferred embodiment of this invention will use a packet-switched network to prevent network bandwidth going to waste while the processor is waiting for the memory controller to return data. While the transaction is occurring the processor is free to continue with other work. The packet-switched processor/memory network functions by carrying transaction packets between the processors and memories and back. Each processor and memory has a unique number marking its geographical position in the network for routing purposes. In the preferred embodiment, the network uses a hypercube topology where each node in the network will contain a processor, a router, and a memory controller. The router needs O(log\hat{ }n) ports for 0(n) nodes, and as such can be built into a single unit, giving only 3 devices per node.

The preferred embodiment of the present invention provides a memory controller that is able to perform logical and arithmetic operations on memory on behalf of a processor. A processor need only make a single memory transaction to perform complex operations and does not need critical sections.

The memory controller has, or can efficiently gain, exclusive access to the memory. It receives transactions from the processors over the network, performs them in such an order that operations intended to be atomic appear functionally atomic, and, if required, returns any result back to the processor.

The preferred embodiment of the memory controller will contain a linear pipeline consisting of a transaction request input buffer, a transaction decoder, a memory access stage, an Arithmetic Logic Unit, a set of registers, and a transaction result output buffer to return data back to the processor via the network. A memory data cache can be used to improve throughput. Transactions will be broken down into micro-operations which will be fed through the pipeline sequentially to implement complex transactions. For example, a swap operation may be broken down to a read followed by a write, with the result of the read being sent back to the processor.

The memory controller manages the physical memory, with one controller per memory leaf. It has access to a block of RAM and provides I/O facilities for peripherals. The memory controller receives transaction packets from the network. Each packet is decoded, and complex operations such as test-and-set or arithmetic operations are broken down to micro-operations. These micro-operations are inserted into a pipeline on consecutive clock cycles. Once all micro-operations pertaining to any given transaction have been issued the memory controller moves onto the next, if any, transaction packet. The pipeline is linear and resembles a RISC processor. Memory can be read and written, a set of registers hold intermediate results, and an Arithmetic Logic Unit is present to perform complex operations. Thus the memory controller can perform calculations directly on memory on behalf of the processor for the cost of only a single memory transaction.

In the preferred embodiment, in order to increase bandwidth of the shared memory, the memory is divided into small equal sized leaves. This is a well known technique and the interleaving can be done on any scale from bytes upwards. If there were 4 leaves with interleaving at the byte level, then leaf 0 would contain bytes 0,4,8,12,16, etc.; leaf 1 would contain bytes 1,5,9,13,17, etc.; and so on. With interleaving at the 32-bit word level, leaf 0 would contain bytes 0,1,2,3,16,17,18,19, etc.; leaf 1 would contain 4,5,6,7,20,21,22,23, etc.; and so on.

FIG. 2 illustrates, in schematic form, a memory configuration in accordance with the invention.

With reference to FIG. 2, the memory configuration 20 is interleaved at the frame level, and the plurality of processors 21 is connected through a network 22 to a plurality of memory leaves 23. All memory is divided into leaves 23, with one controller 24 per memory leaf. The memory unit is therefore a leaf comprising a plurality of frames 25. Memory units are interleaved at the frame level, so consecutive frames 25 run across consecutive memory leaves 23.

In the memory addressing scheme 26, the lower bits 27 of the logical address 28 can be equated to the network position of the memory leaf, making network routing trivial. The logical address 28 is the system-wide address of which each word has a unique value. It is converted to a physical address 29 which is an index to the physical memory. The physical address 29 is used by the memory controller 24 to access words in its own memory unit. Leaf number 27 is extracted and used for routing purposes and equates to the network position of the memory controller 24. If not all nodes have memory leaves, then not all leaf numbers will be utilised, and there will be gaps in the logical addressing, but this will be hidden by the virtual address mapping.

In the memory addressing scheme 26, W 30 is the word offset within a frame.

Each memory controller can consider its own local memory to have contiguous addressing. A frame is the unit of allocation. For arbitrary sized blocks of RAM, as functions such as C's malloco may wish to create, lots of frames are allocated to give a sufficiently large collective size. These frames can be at any address on any leaf, leading to fragmentation. The fragmentation is rendered invisible by mapping each frame's address to a virtual address. In the preferred embodiment, the virtual address should correspond to the same leaf as the physical address of the frame to which it refers in order to simplify network routing.

A set of dedicated registers hold pointers to the heads and tails of linked lists in memory. There is also a pointer to the top of the allocated free heap. All registers are typically initialised to zero on a reset. The lists are used for the throttle's thread context list and also for allocating arbitrary frames of memory. Handling of the pointers is performed in hardware, with the processor only needing to request reads or writes to or from specific addresses set aside for such a purpose. For instance, when a memory frame is requested to be allocated, the controller first tries to pull a previously released frame off the linked list pertaining to memory allocation. If the list is empty then a new frame is taken off the end of the free store. When a frame is released its address is attached to the linked list so it can be reused later on. The throttle stores thread contexts in memory frames which are allocated and then have their addresses attached to the context list. When the thread is resurrected the address is taken off the context list and the frame is released.

Further modification and improvements may be added without departing from the scope of the invention herein described.

1. A multi-processor computer system comprising a plurality of processors and a plurality of memory units characterised in that each memory unit is operated on by its own memory controller means for the purpose of performing processing operations on said memory unit.

2. A system as claimed in any preceding Claim, wherein said processing operations are atomic.

3. A system as claimed in any preceding Claim, wherein said plurality of processors are connected to said plurality of controller means by a network.

4. A system as claimed in claim 3, wherein said network comprises a packet-switched network.

5. A system as claimed in any of claims 3 to 4, wherein said network defines a hyper-cube topology.

6. A system as claimed in any of claims 3 to 5, wherein said network comprises a plurality of nodes, wherein each node comprises a router, and at least one other element being selected from a list consisting of:
a processor;
a memory controller means; and
a memory unit.

7. A system as claimed in any preceding Claim, wherein said plurality of processors compiles at least one transaction packet which comprises information, and being selected from a list consisting of:
information related to routing said transaction packets to a memory controller means;
information which specifies a processing operation;
information related to routing said transaction packets back from said memory controller means;
and information related to matching said transaction packet to a process thread.

8. A system as claimed in any preceding Claim, wherein each of said plurality of processors is associated with a unique identifier for the purposes of routing.

9. A system as claimed in any preceding Claim, wherein each of said plurality of memory controller means is associated with a unique identifier for the purposes of routing.

10. A system as claimed in any preceding Claim, wherein said memory controller means accesses a block of RAM.

11. A system as claimed in any preceding Claim, wherein said memory controller means provides input/output facilities for peripherals.

12. A system as claimed in any preceding Claim, wherein said memory controller means comprises processing elements being selected from a list consisting of:
a processing operation request input buffer;
a processing operation decoder;
a memory access stage;
an arithmetic logic unit;
a set of registers; and
a processing operation result output buffer.

13. A system as claimed in any preceding Claim, wherein said memory unit is a computer memory divided into frames.

14. A system as claimed in any preceding Claim, wherein said memory unit defines a computer memory leaf which comprises one or more frames.

15. A system as claimed in claim 14, wherein a plurality of said memory units are interleaved at the frame level.

16. A system as claimed in any of claims 14 to 15, wherein a set of bits of logical addresses are equated to the network position of said leaves.

17. A system as claimed in any of claims 13 to 16, wherein the address of at least one of said frames are mapped to a virtual address.

18. A system as claimed in claim 17, wherein said virtual address corresponds to the same leaf as the physical address of the frame to which the virtual address refers.

19. A system as claimed in any of claims 13 to 18, wherein a set of registers in said memory controller means hold pointers to link lists for allocating said frames.

20. A method of performing processing operations in a shared memory multi-processor computer comprising the steps of:
requesting that a memory controller means perform a processing operation on a memory unit; and
said memory controller means performing said requested processing operation on said memory unit;
characterised in that each memory unit is operated on by its own memory controller means for the purpose of performing processing operations on said memory unit.

21. A method as claimed in claim 20, wherein said processing operations are atomic.

22. A method as claimed in any of claims 20 to 21, wherein said request is transmitted across a network.

23. A method as claimed in claim 22, wherein said network comprises a packet-switched network.

24. A method as claimed in any of claims 22 to 23, wherein said network defines a hyper-cube topology.

25. A method as claimed in any of claims 22 to 24, wherein said network comprises a plurality of nodes, wherein each node comprises a router, and at least one other element being selected from a list consisting of:
a processor;
a memory controller means; and
a memory unit.

26. A method as claimed in any of claims 20 to 25, wherein said request comprises at least one transaction packet which comprises information, and being selected from a list consisting of:
information related to routing said transaction packets to a memory controller means;
information which specifies a processing operation;
information related to routing said transaction packets back from said memory controller means;
and information related to matching said transaction packet to a process thread.

27. A method as claimed in any of claims 20 to 26, wherein each of said plurality of processors is associated with a unique identifier for the purposes of routing.

28. A method as claimed in any of claims 20 to 27, wherein each of said plurality of memory controller means is associated with a unique identifier for the purposes of routing.

29. A method as claimed in any of claims 20 to 28, wherein said memory controller means accesses a block of RAM.

30. A method as claimed in any of claims 20 to 29, wherein said memory controller means provides input/output facilities for peripherals.

31. A method as claimed in any of claims 20 to 30, wherein said memory controller means comprises processing elements being selected from a list consisting of:
a processing operation request input buffer;
a processing operation decoder;
a memory access stage;
an arithmetic logic unit;
a set of registers; and
a processing operation result output buffer.

32. A method as claimed in claim 31, wherein said memory controller means divides said processing operation into micro-operations which are performed by a pipeline of said processing elements.

33. A method as claimed in any of claims 20 to 32, wherein said memory unit is a computer memory divided into frames.

34. A method as claimed in any of claims 20 to 33, wherein said memory unit defines a computer memory leaf which comprises one or more frames.

35. A method as claimed in claim 34, wherein a plurality of said memory units are interleaved at the frame level.

36. A method as claimed in any of claims 34 to 35 wherein a set of bits of logical addresses are equated to the network position of said leaves.

37. A method as claimed in any of claims 33 to 36, wherein the address of at least one of said frames are mapped to a virtual address.

38. A method as claimed in claim 37, wherein said virtual address corresponds to the same leaf as the physical address of the frame to which the virtual address refers.

39. A method as claimed in claims 33 to 38, wherein a set of registers in said memory controller means hold pointers to link lists for allocating said frames.
